(19) United States
(12) Patent Application Publication
(10) Pub. No.: US 2011/0101634 A1
(43) Pub. Date: May 5, 2011

(54) UNIVERSAL SKI CONVERSION DEVICE FOR A BICYCLE TRAILER

(76) Inventor: Charles M. Love, Durango, CO (US)

(21) Appl. No.: 12/916,091

(22) Filed: Oct. 29, 2010

Related U.S. Application Data
(60) Provisional application No. 61/256,503, filed on Oct. 30, 2009.

(51) Int. Cl. B62B 9/04

(52) U.S. Cl. 280/13

(57) ABSTRACT

A ski conversion device for a bicycle trailer with first and second wheels, including: first and second wheel braces for attachment to first and second skis and for receiving the first and second wheels, respectively; first and second yoke braces for attachment to the first and second skis, respectively; a plurality of strap braces for attachment to the first and second skis; a first plurality of connecting elements for fixing the first and second wheels with respect to the first and second wheel braces, respectively; a plurality of stabilizing straps for connecting the trailer to the plurality of strap braces and for fixing an orientation of the trailer with respect to the first and second skis; and first and second yokes with respective first ends connected to the first and second yoke braces, respectively, the first and second yokes attachable to a source of energy for propelling the ski conversion device.

### CROSS-REFERENCE TO RELATED APPLICATIONS

This application claims the benefit under 35 U.S.C. §119(e) of U.S. Provisional Application No. 61/256,503, filed Oct. 30, 2009.

### FIELD OF THE INVENTION

The present disclosure relates to improvements in ski conversion device for a bicycle trailer. In particular, the present disclosure relates to a ski conversion device that is adapted for use with a wide variety of bicycle trailer configurations.

### BACKGROUND OF THE INVENTION

The prior art teaches ski conversion kits that require complete removal of the wheels and subsequent replacement of the wheels with a ski assembly. Thus, the prior art teaches away from a ski conversion kit that can be used with a trailer having wheels. Also, the prior art teaches conversion kits that are only compatible with a single brand/model of ski trailer. Thus, the prior art teaches away from a ski conversion kit adaptable to different brands or models of ski trailers.

### BRIEF SUMMARY OF THE INVENTION

According to aspects illustrated herein, there is provided a ski conversion device for a bicycle trailer with first and second wheels, including: first and second wheel braces for attachment to first and second skis and for receiving the first and second wheels, respectively; first and second yoke braces for attachment to the first and second skis, respectively; a plurality of strap braces for attachment to the first and second skis; a first plurality of connecting elements for fixing the first and second wheels with respect to the first and second wheel braces, respectively; a plurality of stabilizing straps for connecting the trailer to the plurality of strap braces and for fixing an orientation of the trailer with respect to the first and second skis; and first and second yokes with respective first ends connected to the first and second yoke braces, respectively, the first and second yokes attachable to a source of energy for propelling the ski conversion device.

According to aspects illustrated herein, there is provided a ski conversion device for a bicycle trailer with first and second wheels, including: first and second wheel braces for attachment to respective top surfaces for first and second skis and for receiving the first and second wheels, respectively; first and second yoke braces for attachment to the first and second skis, respectively; a plurality of strap braces for attachment to the first and second skis; a first plurality of connecting elements for fixing the first wheel with respect to the first wheel brace; a second plurality of connecting elements for fixing the second wheel with respect to the second wheel brace; a plurality of stabilizing straps for connecting the trailer to the plurality of strap braces and for fixing an orientation of the trailer with respect to the first and second skis; first and second yokes with respective first ends connected to the first and second yoke braces, respectively, the first and second yokes attachable a source of energy for propelling the ski conversion device; a stabilizing element for connection to the first ski such that a portion of the stabilizing element extends beyond a bottom surface of the first ski, opposite the top surface of the first ski, in a direction away from the top surface; a brake element with a distal end and a first end for connection to an end of the first ski; and a rigger element including a central element connectable to the first ski, a runner element, and an arm connecting the runner element to the central element. For movement of the first ski across a surface in a first direction, from the first wheel brace toward the first yoke brace, the brake element is for pivoting with respect to the end of the first ski such that the distal end slides over the surface. For movement of the first ski across the surface in a second direction, opposite the first direction, the brake element is for pivoting with respect to the first ski such that the distal end engages the surface to resist movement of the first ski in the second direction. In a first position, the runner element is locatable between the second ski and a first side of the first ski facing the second ski. In a second position, the runner element is locatable beyond a second side of the first ski, opposite the first side of the first ski, with respect to a direction from the first side to the second side.

According to aspects illustrated herein, there is provided a method for converting a bicycle trailer with first and second wheels for use with first and second skis, including: attaching first and second wheel braces to the first and second skis; inserting the first and second wheels into the first and second wheel braces, respectively; attaching first and second yoke braces to the first and second skis, respectively; attaching a plurality of strap braces to the first and second skis; fixing the first and second wheels with respect to the first and second wheel braces, respectively, using a first plurality of connecting elements; connecting the trailer to the plurality of strap braces with a plurality of stabilizing straps; fixing an orientation of the trailer with respect to the first and second skis using the plurality of stabilizing straps; and connecting respective first ends of first and second yokes to the first and second yoke braces, respectively.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a perspective view of a ski conversion device for a bicycle trailer;

FIG. 2 is an exploded detail of a yoke connection brace shown in FIG. 1;

FIG. 3 is a detail of a stabilizing element for the ski conversion device shown in FIG. 1;

FIG. 4 is a detail of a brake element for the ski conversion device shown in FIG. 1; and,

FIG. 5 is a detail of a rigger element for the ski conversion device shown in FIG. 1.

### DETAILED DESCRIPTION OF THE DISCLOSURE

At the outset, it should be appreciated that like drawing numbers on different drawing views identify identical, or functionally similar, structural elements of the present disclosure. It is to be understood that the present disclosure as claimed is not limited to the disclosed aspects.

Unless defined otherwise, all technical and scientific terms used herein have the same meaning as commonly understood to one of ordinary skill in the art to which the present disclosure belongs. Although any methods, devices or materials similar or equivalent to those described herein can be used in the practice or testing of these embodiments, some embodiments of methods, devices, and materials are now described.

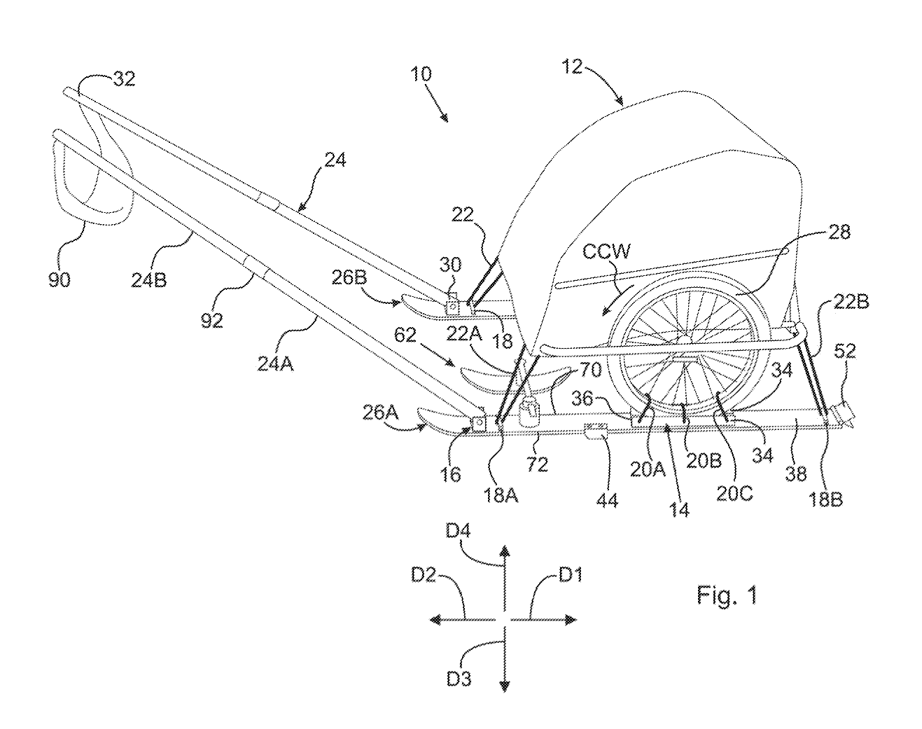

FIG. 1 is a perspective view of ski conversion device, or kit, 10 for bicycle trailer 12.

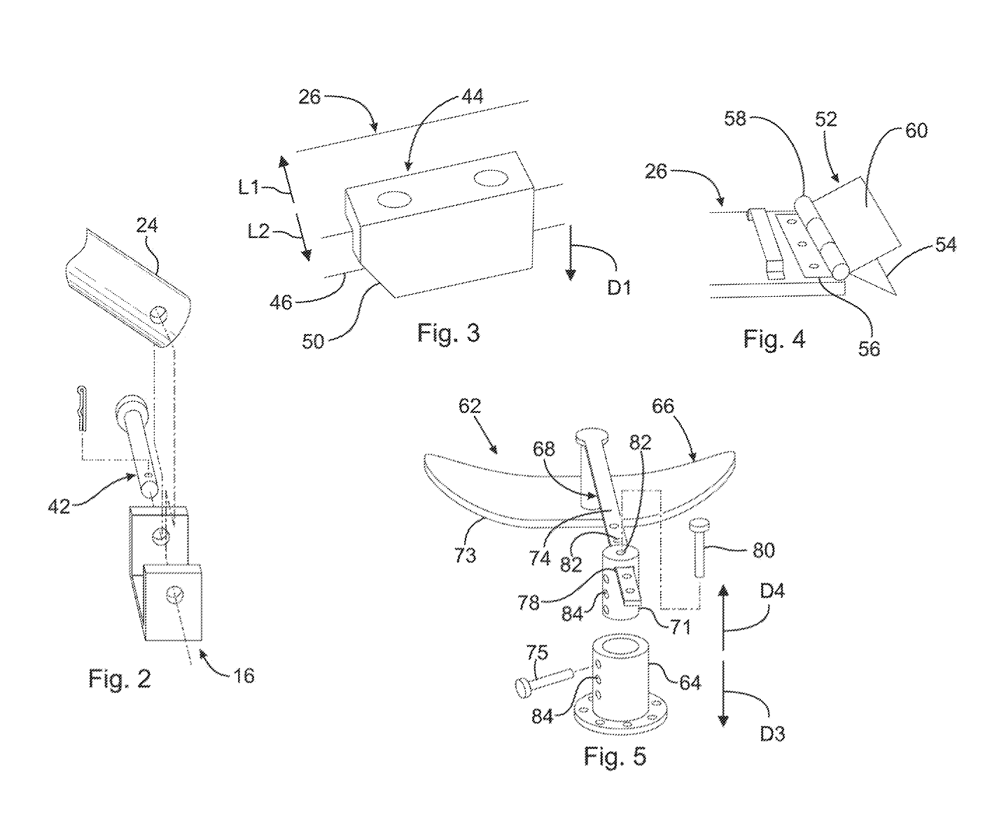

FIG. 2 is a detail of a yoke connection brace shown in FIG. 1. The following should be viewed in light of FIGS. 1 and 2. In general, device 10 is connected to the trailer as described infra, to enable the trailer to be connected to a source of energy for propelling the ski conversion device, for example, a person on skis, snowshoes, or foot. Device 10 includes wheel braces 14, yoke braces 16, strap braces 18, connecting elements 20, stabilizing straps 22, and yokes 24. Wheel braces 14 are for attachment to skis 26 and for receiving wheels 28 for the trailer. The yoke braces 16 and strap braces 18 are for attachment to the ski. The connecting elements are for fixing the wheels with respect to the wheel braces. The stabilizing straps are for connecting the trailer to the strap braces and for fixing an orientation of the trailer with respect to the skis. The yoke braces include ends 30 connected to the yoke braces. Distal ends 32 of the yokes are attachable to a source of energy for propelling the ski conversion device, as further described below.

The wheel braces, strap braces, and yoke braces are attached to the skis by any means known in the art, including, but not limited to, threaded fasteners or rivets. Any strap or securing device known in the art can be used for elements 20 and straps 22, including, but not limited to, resilient straps, quick-release devices, and ratcheting devices.

In an example embodiment, the wheel brace is U-shaped, or channel-shaped piece with side walls 34 and bottom portion 36 joining the side walls. In an example embodiment, the bottom wall is in contact with top surface 38 of the skis. The width of the wheel braces (between walls 34) is sufficient to receive any bicycle trailer tire known in the art. In an example embodiment (not shown), each wheel brace is integrally formed with a respective ski, for example, the wheel brace is formed of a same piece of material forming the top of the ski.

In an example embodiment, a single connecting element is used to fix a wheel with respect to a wheel brace. In an example embodiment, multiple connecting elements, for example, 20A through 20C are used to fix a wheel with respect to a wheel brace. The multiple connection elements exert at least partially opposing forces in directions D1 and D2 on the wheel to further stabilize the wheel with respect to the wheel brace. It should be understood that other multiple connection element configurations are possible, such as only elements 20A and 20C without middle element 20B.

In an example embodiment, the yokes are pivotable with respect to the yoke braces. For example, the yoke braces include pins 42 passing through the braces and ends 30 of the yokes. The yokes are pivotable about the pins, and thus, pivotable with respect to the skis and the trailer. Any pin configuration known in the art can be used. In an example embodiment, the pins are configured for quick-disconnect by any means known in the art, for example, in a cotter pin arrangement, to enable easy connection and disconnection of the yokes from the yoke braces.

In an example embodiment, for each ski, a group of stabilizing straps, for example, straps 22A and 22B, are for connection to respective strap braces, for example, braces 18A and 18B, and for exerting at least partially opposing forces in directions D1 and D2 on the trailer to stabilize the trailer with respect to the skis.

FIG. 3 is a detail of stabilizing element 44 for ski conversion device 10 shown in FIG. 1. The skis include top surface 38 and bottom surface 46, opposite the top surface. In an example embodiment, the ski conversion device includes stabilizing element 44 connectable to a ski such that portion 50 of the stabilizing element extends beyond the bottom surface in direction D3 away from the top surface. Element 44 enables movement of the ski in forward direction D2, while preventing undesirable sliding or slippage in lateral direction L1 or L2, orthogonal to D2. Element 44 can be connected to the ski by any means known in the art, including, but not limited to, threaded fasteners or rivets. In an example embodiment (not shown), each stabilizing element 44 is integrally formed with a respective ski, for example, the stabilizing element is formed of a same piece of material forming at least a portion of the ski.

Although the stabilizing element is shown attached to ski 26A, it should be understood that the stabilizing element can be attached to ski 26B instead. It also should be understood that a respective stabilizing element can be attached to each of the skis. It should be understood that more than one stabilizing element can be attached to a ski. It should be understood that a stabilizing element is not limited to a particular position on a ski, for example, a stabilizing element can be attached anywhere along the length of a ski and can be attached to an outside edge of a ski as shown in FIG. 3 or can be attached to an inside edge of a ski (not shown), facing the other ski. Any combination of positions and numbers of stabilizing elements are possible.

FIG. 4 is a detail of brake element 52 for ski conversion device 10 shown in FIG. 1. In an example embodiment, the ski conversion device includes brake element 52 with distal end 54 and end 56 for connection to an end of a ski. End 56 can be connected to the ski by any means known in the art, including, but not limited to, threaded fasteners or rivets. In an example embodiment, the brake element pivots with respect to the ski, for example, hinge, or pivot, 58 connects end 56 with body 60 of the brake element. For movement of the ski across a surface (not shown) in forward direction D2, the brake element is for pivoting with respect to the end of the ski such that the distal end slides over the surface. That is, the distal end does not dig into the surface and the brake element offers only nominal resistance to movement across the surface. Stated otherwise, the force interaction of the brake element with the surface tends to push the brake element away from the surface. For movement of the ski across the surface in backward direction D1, the body and distal end of the brake element pivot with respect to the ski such that the distal end engages, or digs into, the surface to resist movement of the ski in the backward direction. That is, the force interaction of the brake element with the surface tends to cause the brake element to burrow into the surface, inhibiting the movement of the ski in direction D1.

FIG. 5 is a detail of rigger element 62 for ski conversion device 10 shown in FIG. 1. The rigger element includes central element 64 connectable to a ski, for example, ski 26A, runner element 66, and arm 68 connecting the runner element to the central element. Element 64 can be connected to the ski by any means known in the art, including, but not limited to, threaded fasteners or rivets. In one position, the runner element is locatable between the skis, for example, skis 26A and 26B. For example, as shown in the figures, the runner element is on a first side of the ski to which the rigger element is attached, for example, side 70, facing the other ski, for example, ski 26B, parallel to ski 26A. In another position (not shown), the runner element is locatable beyond a second side of the ski to which the rigger element is attached, for example, side 72, opposite the first side, with respect to direction L2 from the first side to the second side. Thus, the runner element is located beyond the outside edge of the ski to which the rigger element is attached.

In an example embodiment, the height of the runner element, for example, with respect to the top or bottom surface of the ski to which the rigger element is attached, and the distance of the runner element from the ski to which the rigger element is attached can be adjusted using the arm. Although the rigger element is shown attached to ski 26A, it should be understood that the rigger element can be attached to ski 26B instead. It also should be understood that a respective rigger element can be attached to each of the skis. It should be understood that more than one rigger element can be attached to a ski. It should be understood that a rigger element is not limited to a particular position on a ski.

In an example embodiment, in a first position, bottom surface 73 of the runner element is located, in direction D3 from the top surface toward the bottom surface of the ski, beyond the bottom surface of the ski. In an example embodiment, in a second position, the bottom surface of the runner element is located, in direction D4, opposite direction D3, beyond the bottom surface of the ski. For example, for the second position, the position of the runner element with respect to the bottom surface of ski 26 can be set such that skis 26 bear the main weight of the trailer and the rigger element act as an outrigger to stabilize the trailer in a side-to-side direction.

For example, if the ski device and trailer are being used on a groomed trail with grooves in the surface for cross-country skis, and a rigger element is installed on one or both of skis 26, the rigger element or elements can be placed in the position shown in FIG. 1, and the respective positions of the runner elements with respect to sides 70 can be set such that each runner element engages a respective groove. The respective positions of the runner elements with respect to the bottom surfaces of skis 26 can be set such that the runner elements bear the main weight of the trailer and skis 26 act as outriggers to stabilize the trailer in a side-to-side direction. Thus, advantage can be taken of the grooves to maintain the trailer in a stable position.

In an example embodiment, runner 66 is in the shape of a ski. Runner 66 is not limited to a particular length, width, or shape. In an example embodiment, arm 68 includes portion 71 disposed within central portion 64. In an example embodiment, portion 71 swivels, or rotates, within central portion 64 to attain the first and second positions noted above. Portion 71 is lockable in the first or second positions by any means known in the art, for example, pins 75. In an example embodiment (not shown), central portion 64 and portion 71 have matching configurations, for example, both have a square shape, such that portion 71 can slide in and out of portion 64 and is fixed with respect to the central portion when disposed within the central portion. To move arm 68 to the first or second position, portion 71 is lifted out of the central portion and then re-inserted with the arm in the desired orientation.

In an example embodiment, arm 68 includes lateral portion 74. In an example embodiment, the length of portion 74 is fixed. In an example embodiment, the length of portion 74 can be adjusted by any means known in the art. For example, portion 64 includes slot 78 and portion 74 is slidable through the slot. The position of portion 74 in the slot determines the distance from portion 64 to the runner element (the length of the arm). Portion 74 can be fixed in the slot by any means known in the art, for example, pin 80 and openings 82.

As noted above, the height of the runner element, for example, with respect to the top surface of a ski can be adjusted using the arm and any means known in the art. For example openings 84 in portions 64 and 71 and pin 75 can be used. Portion 71 is moved up or down within portion 64 until respective openings 84 in portions 64 and 71 associated with a desired position of the runner element are aligned. Pin 75 is then inserted in the respective openings to lock portion 71 with respect to portion 64. Pins 75 and 80 can be any pin known in the art. In an example embodiment, pins 75 and/or 80 include a quick release feature.

Further details are now provided. Each wheel of the trailer is positioned in a respective wheel brace. If the tires of the wheels are not in contact with one or both the side walls of the respective braces, for example, if the tires are narrower than the width of the wheel brace (distance between walls 34), shims (not shown) can be inserted to take up the space between the tires and the side walls. Any shim known in the art can be used. In an example embodiment, the shims are rectangular plates. In an example embodiment (not shown), the side walls for the wheel braces are laterally displaceable, that is, the width between the side walls in the wheel brace is adjustable to firmly grip a wheel inserted in the wheel brace. The wheel brace is not limited to any particular width adjustment.

The wheel braces, connecting elements, and shims, if used, stabilize the wheels in first and second direction substantially parallel to and orthogonal to, respectively, the axle for wheels 28. Specifically, connecting elements 20 are used to secure the wheels of the trailer to the wheel braces. For example, the connecting elements are positioned over respective inner circumferences, or rims, of the wheels. The connecting elements are secured to the wheel braces by any means known in the art and are tightened by any means known in the art. Tightening the connecting elements urges the wheels into the brace and in conjunction with the wheel braces and shims, if used, firmly holds the wheels in place in the wheel braces. That is, the straps prevent the wheels from rolling forward or backward within the wheel braces or from lifting out of the wheel braces. Thus, the connecting element arrangement enables a locking of the wheels of the trailer with the wheel braces.

To stabilize the trailer with respect to the skis, for example, to prevent the trailer from rocking by swiveling around the axle for the wheels, and to fix a desired orientation of the trailer with respect to the skis, stabilizing straps 22 are connected to the strap braces and to the trailer. In an example embodiment, straps 22 are looped through strap braces 18 and a portion of the trailer. The straps are then cinched and tightened using any means known in the art. By adjusting opposing straps, for example, straps 22A and 22B, the trailer is prevented, by the opposing forces applied to the trailer by the opposing straps, from swiveling about the axle. The orientation of the trailer with respect to the skis, that is, the position of the trailer with respect to the axle is determined by the respective lengths of opposing straps. For example, shortening strap 22A, while lengthening strap 22B, causes the trailer to rotate about the wheel axle in counterclockwise direction CCW.

In an example embodiment (not shown), rigid elements are used in place of some or all of straps 22. For example, the rigid elements could be formed in a manner similar to that for the yokes and the discussion regarding yokes is applicable to the rigid elements.

In an example embodiment (not shown), one or more bands are placed about the trailer, or one or more securing elements are connected to the trailer, for example, a securing element is a clamp. The straps are secured to the band(s) or securing element(s), for example, rather than being placed, or looped, through a structural component of the trailer.

The yoke braces enable desired movement of the yokes, while limiting or eliminating undesired movement of the yokes. Thus, swivel portions of the yoke braces, for example, pins 42, provide pivoting connection between the yokes and the skis. For example, the swivel portion enables swiveling movement of the yokes in a direction roughly orthogonal to the ground, for example, D3 or D4, that is, an up-down movement, while substantially limiting sideways movement of the yokes, for example, in directions L1 or L2. Thus, movement of the distal ends of the yokes (the ends furthest from the trailer), for example, as would be associated with relative movement between a user of the conversion device and the trailer, for example, due to changes in the terrain or movement of the source of energy for propelling the ski conversion device, is accommodated while enabling the trailer to maintain a substantially stable orientation with respect to forward direction D2. For example, the trailer is not necessarily lifted by an upward motion of the distal ends of the yokes.

The source of energy for propelling device 10 is attached to the distal ends of the yokes by any means known in the art. In an example embodiment, padded waist belt 90 is connected to the distal ends of the yokes. In an example embodiment, the respective lengths of the yokes are adjustable. For example, each yoke includes telescoping portions 24A and 24B. Any telescoping configuration known in the art can be used. For example, portion 24B is slidable within portion 24A and any means known in the art can be used to secure the portions together. That is, once portion 24B is displaced within portion 24A to a desired extent, the portions can be locked together to maintain the relative position of the portions. Portions 24A and 24B are not limited to any particular length or diameter.

In an example embodiment, the yokes are modular. For example, portions 24A and 24B can be connected by any quick-disconnect joint 92 known in the art and one or more additional yoke portions can be inserted between, or at either end of, portions 24A and 24B. Also, one or both of portions 24A and 24B can be removed or replaced with a different length of yoke. Thus, the respective overall lengths of the yokes can be customized and made proportional to the size or preference of the end user. Connecting the yokes to a belt or harness system enables a person pulling trailer 12 on skis 26 to keep their hands free. Yoke 24 is sufficiently rigid to maintain a substantially constant distance between the trailer and a person pulling the trailer. That is, the yokes hold the skis away from the source of energy for propelling the ski conversion device. The lateral, or side-to-side, rigidity of the yokes in the yoke braces keeps the trailer aligned with a person pulling the trailer, preventing the trailer from sliding laterally. That is, the rigidity of the connectors minimizes lateral movement of the trailer with respect to the person while maintaining the ability of the yokes to swivel in an up-down direction.

In an example embodiment, attachment devices, for example, clips, connected to ends 32 of the yokes are suitable for connection to any device known in the art for interface with a person, animal, or machine pulling device 10, for example, including a backpack, clothing, a harness or trace for an animal, or a powered vehicle, such as a snow mobile.

Advantageously, the flexibility and adaptability inherent in device 10 enables device 10 to be used with a wide variety of bicycle trailers. For example, the wheel braces and the shims are adaptable to a wide range of wheel/tire widths. The length adjustability of the connecting elements enables the straps to be used with a wide range of wheels/tire widths and diameters. In like manner, stabilizing straps 22 are readily adaptable to a wide range of sizes and shapes for trailer 12, for example, due to the adjustability of the straps and the ability for a user to select a location on the skis for the strap braces. Thus, device 10 is usable with virtually any bicycle trailer.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What I claim is:

1. A ski conversion device for a bicycle trailer with first and second wheels, comprising:
first and second wheel braces for attachment to first and second skis and for receiving the first and second wheels, respectively;
first and second yoke braces for attachment to the first and second skis, respectively;
a plurality of strap braces for attachment to the first and second skis;
a first plurality of connecting elements for fixing the first and second wheels with respect to the first and second wheel braces, respectively;
a plurality of stabilizing straps for connecting the trailer to the plurality of strap braces and for fixing an orientation of the trailer with respect to the first and second skis; and,
first and second yokes with respective first ends connected to the first and second yoke braces, respectively, the first and second yokes attachable to a source of energy for propelling the ski conversion device.

2. The ski conversion device of claim 1, wherein:
the first and second wheel braces have respective U-shapes with respective side walls and respective bottom portions joining the respective side walls;
the first and second wheels are disposable between the respective parallel walls; and,
the first plurality of connecting elements is for fixing the first and second wheels with respect to the respective side walls.

3. The ski conversion device of claim 2, wherein the first plurality of connecting elements includes:
a first single connecting element for fixing the first wheel with respect to the respective side walls; and,
a second single connecting element for fixing the second wheel with respect to the respective side walls.

4. The ski conversion device of claim 2, wherein the first plurality of connecting elements includes:
a second plurality of connecting elements for fixing the first wheel with respect to the respective side walls; and,
a third plurality of connecting elements for fixing the second wheel with respect to the respective side walls.

5. The ski conversion device of claim 4, wherein:
the second plurality of connecting elements is for exerting first at least partially opposing forces on the first wheel; and,
the third plurality of connecting elements is for exerting second at least partially opposing forces on the second wheel.

6. The ski conversion device of claim 1, wherein:
the first and second yoke braces include respective pins passing through the respective first ends of the first and second yokes; and,
the first and second yokes are pivotable about the respective pins.

7. The ski conversion device of claim 1, wherein the first and second yoke:
include respective first and second telescoping portions; or,
are modular to enable attachment of additional portions for the yokes.

8. The ski conversion device of claim 1, wherein:
first and second groups of strap braces from the plurality of strap braces are for connection to the first and second skis, respectively;
a first group of stabilizing straps from the plurality of stabilizing straps is for connection to the first group of strap braces and for exerting first at least partially opposing forces on the trailer; and,
a second group of stabilizing straps from the plurality of stabilizing straps is for connection to the second group of strap braces and for exerting second at least partially opposing forces on the trailer.

9. The ski conversion device of claim 1, wherein the first ski includes:
a top surface to which the first wheel brace is connectable; and,
a bottom surface, opposite the top surface, the ski conversion device further comprising a stabilizing element for connection to the first ski such that a portion of the stabilizing element extends beyond the bottom surface in a direction away from the top surface.

10. The ski conversion device of claim 1, further comprising a brake element with a distal end and a first end for connection to an end of the first ski, wherein:
for movement of the first ski across a surface in a first direction, from the first wheel brace toward the first yoke brace, the brake element is for pivoting with respect to the end of the first ski such that the distal end slides over the surface; and,
for movement of the first ski across the surface in a second direction, opposite the first direction, the brake element is for pivoting with respect to the first ski such that the distal end engages the surface to resist movement of the first ski in the second direction.

11. The ski conversion device of claim 1, further comprising a rigger element including a central element connectable to the first ski, a runner element, and an arm connecting the runner element to the central element, wherein:
in a first position, the runner element is locatable between the second ski and a first side of the first ski facing the second ski; and,
in a second position, the runner element is locatable beyond a second side of the first ski, opposite the first side of the first ski.

12. The ski conversion device of claim 10, wherein:
the first ski includes:
a top surface to which the first wheel brace is connectable; and,
a bottom surface, opposite the top surface;
in the first position, a bottom surface of the runner element is located, in a first direction from the top surface toward the bottom surface, beyond the bottom surface; and,
in the second position, a bottom surface of the runner element is located, in a second direction, opposite the first direction, beyond the bottom surface.

13. A ski conversion device for a bicycle trailer with first and second wheels, comprising:
first and second wheel braces for attachment to respective top surfaces for first and second skis and for receiving the first and second wheels, respectively;
first and second yoke braces for attachment to the first and second skis, respectively;
a plurality of strap braces for attachment to the first and second skis;
a first plurality of connecting elements for fixing the first wheel with respect to the first wheel brace;
a second plurality of connecting elements for fixing the second wheel with respect to the second wheel brace;
a plurality of stabilizing straps for connecting the trailer to the plurality of strap braces and for fixing an orientation of the trailer with respect to the first and second skis;
first and second yokes with respective first ends connected to the first and second yoke braces, respectively, the first and second yokes attachable to a source of energy for propelling the ski conversion device;
a stabilizing element for connection to the first ski such that a portion of the stabilizing element extends beyond a bottom surface of the first ski, opposite the top surface of the first ski, in a direction away from the top surface;
a brake element with a distal end and a first end for connection to an end of the first ski; and,
a rigger element including a central element connectable to the first ski, a runner element, and an arm connecting the runner element to the central element, wherein:
for movement of the first ski across a surface in a first direction, from the first wheel brace toward the first yoke brace, the brake element is for pivoting with respect to the end of the first ski such that the distal end slides over the surface;
for movement of the first ski across the surface in a second direction, opposite the first direction, the brake element is for pivoting with respect to the first ski such that the distal end engages the surface to resist movement of the first ski in the second direction;
in a first position, the runner element is locatable between the second ski and a first side of the first ski facing the second ski; and,
in a second position, the runner element is locatable beyond a second side of the first ski, opposite the first side of the first ski, with respect to a direction from the first side to the second side.

14. A method for converting a bicycle trailer with first and second wheels for use with first and second skis, comprising:
attaching first and second wheel braces to the first and second skis;
inserting the first and second wheels into the first and second wheel braces, respectively;
attaching first and second yoke braces to the first and second skis, respectively;
attaching a plurality of strap braces to the first and second skis;
fixing the first and second wheels with respect to the first and second wheel braces, respectively, using a first plurality of connecting elements;
connecting the trailer to the plurality of strap braces with a plurality of stabilizing straps;
fixing an orientation of the trailer with respect to the first and second skis using the plurality of stabilizing straps; and,
connecting respective first ends of first and second yokes to the first and second yoke braces, respectively.

15. The method of claim 13, wherein:
the first and second wheel braces have respective U-shapes with respective side walls and respective bottom portions joining the respective side walls;
inserting the first and second wheels into the first and second wheel braces, respectively, includes disposing the first and second wheels between the respective parallel walls; and,
fixing the first and second wheels with respect to the first and second wheel braces, respectively, includes fixing the first and second wheels with respect to the respective side walls.

16. The method of claim 13, wherein fixing the first and second wheels with respect to the first and second wheel braces, respectively, includes:
using a second plurality of connecting elements from the first plurality of connecting elements to fix the first wheel with respect to the respective side walls; and,
using a third plurality of connecting elements from the first plurality of connecting elements to fix the second wheel with respect to the respective side walls.

17. The method of claim 13, wherein:
the first and second yoke braces include respective pins passing through the respective first ends of the first and second yokes; and,
the first and second yokes are pivotable about the respective pins.

18. The method of claim 13, wherein:
attaching the first and second wheel braces to the first and second skis includes attaching the first and second wheel braces to respective top surfaces of the first and second skis; and,
the first ski includes a bottom surface, opposite the top surface, the method further comprising connecting a stabilizing element to the first ski such that a portion of the stabilizing element extends beyond the bottom surface in a direction away from the top surface.

19. The method of claim 13, further comprising connecting a first end of a brake element to an end of the first ski, wherein:
for movement of the first ski across a surface in a first direction, from the first wheel brace toward the first yoke brace, the brake element pivots with respect to the end of the first ski such that a distal end of the brake element slides over the surface; and,
for movement of the first ski across the surface in a second direction, opposite the first direction, the brake element pivots with respect to the first ski such that the distal end engages the surface to resist movement of the first ski in the second direction.

20. The method of claim 13, further comprising connecting a central element of a rigger element to the first ski, such that:
in a first position, the runner element is located between the second ski and a first side of the first ski facing the second ski; and,
in a second position, the runner element is located beyond a second side of the first ski, opposite the first side of the first ski.

21. The method of claim 19, wherein:
in the first position, a bottom surface of the runner element is located, in a first direction from the top surface toward the bottom surface, beyond the bottom surface; and,
in the second position, a bottom surface of the runner element is located, in a second direction, opposite the first direction, beyond the bottom surface.
